(19) United States
(12) Patent Application Publication
(10) Pub. No.: US 2025/0373167 A1
(43) Pub. Date: Dec. 4, 2025

(54) ACTIVE CLAMP FLYBACK SHORT CIRCUIT PROTECTION

(71) Applicant: STMicroelectronics International N.V., Geneva (CH)

(72) Inventor: Emanuele De Bartolomeo, Mortara - Pavia (IT)

(21) Appl. No.: 18/680,634

(22) Filed: May 31, 2024

(51) Int. Cl. H02M 3/335; H02M 1/00; H02M 1/32

(52) U.S. Cl. CPC H02M 3/33569; H02M 1/0009; H02M 1/32

(57) ABSTRACT

According to an embodiment, a method for operating an active clamp flyback (ACF) converter is proposed. The method comprises sensing a reverse current sensing signal (RCSS) during a conduction phase of a high-side switch, the RCSS corresponding to a reverse current flowing at the high-side switch during the conduction phase; comparing the RCSS to a threshold; setting a first dead time duration between turning OFF the high-side switch and turning ON a low-side switch in response to the RCSS exceeding the threshold, the first dead time duration being a function of a reverse recovery time of a body diode of the low-side switch; and setting a second dead time duration less than the first dead time duration between turning OFF the high-side switch and turning ON the low-side switch of the ACF converter in response to the RCSS falling below the threshold.

### TECHNICAL FIELD

The present disclosure generally relates to electronic circuits and, in particular embodiments, to short circuit protection for an active clamp flyback.

### BACKGROUND

Flyback converters are commonly used in applications requiring high voltage and low power. In the evolution of these converters, the Active-Clamp-Flyback (ACF) has emerged as an adaptation of the Quasi-Resonant-Flyback (QR). The ACF distinguishes itself by employing a bidirectional switch instead of the traditional passive clamp.

In the ACF, the energy originating from the transformer's leakage inductance, usually lost in a passive setup, is captured by a clamp capacitor. This conserved energy facilitates zero-voltage-switching (ZVS) for the primary switch at the onset of its activation. The ACF contrasts with the conventional QR flyback, which typically fails to achieve ZVS at high-line conditions. The ACF can reach this goal regardless of the input and output voltage levels, resulting in enhanced efficiency and reduced electromagnetic interference (EMI).

In the usual operation of the ACF, monitoring is conducted to track the current coursing through both the high-side and low-side switches to implement over-current protection schemes. Nonetheless, under certain circumstances, such as when a short circuit occurs in either the output rectifier or the secondary windings, this conventional means of over-current protection often falls short in averting the catastrophic failure of the switches.

### SUMMARY

Technical advantages are generally achieved by embodiments of this disclosure, which describe short circuit protection for an active clamp flyback.

A first aspect relates to a method for operating an active clamp flyback converter. The method comprises sensing a reverse current sensing signal during a conduction phase of a high-side switch of the active clamp flyback converter, the reverse current sensing signal corresponding to a reverse current flowing at the high-side switch during the conduction phase; comparing the reverse current sensing signal to a threshold; setting a first dead time duration between turning OFF the high-side switch and turning on of a low-side switch of the active clamp flyback converter in response to the reverse current sensing signal exceeding the threshold, the first dead time duration being a function of a reverse recovery time of a body diode of the low-side switch; and setting a second dead time duration between turning OFF the high-side switch and turning on the low-side switch of the active clamp flyback converter in response to the reverse current sensing signal falling below the threshold, the second dead time duration being less than the first dead time duration.

A second aspect relates to a circuit for overcurrent protection in an active clamp flyback converter. The circuit comprising a comparator configured to receive, at a first input terminal of the comparator, a reverse current sensing signal during a conduction phase of a high-side switch of the active clamp flyback converter, the reverse current sensing signal corresponding to a reverse current flowing at the high-side switch during the conduction phase; receive, at a second input terminal of the comparator, a threshold; generating an output signal based on a comparison between the reverse current sensing signal and the threshold; a multiplexer configured to select between a first input signal and a second input signal based on the output signal of the comparator, the first input signal corresponding to a first dead time duration between turning OFF the high-side switch and turning on a low-side switch of the active clamp flyback converter, the second input signal corresponding to a second dead time duration between turning OFF the high-side switch and turning on the low-side switch of the active clamp flyback converter; and a monostable multivibrator configured to set a time duration between turning OFF the high-side switch and turning on the low-side switch of the active clamp flyback converter based on an output of the multiplexer.

A third aspect relates to a system. The system comprising an active clamp flyback converter comprising a high-side switch and a low-side switch; and a circuit configured for overcurrent protection of the active clamp flyback converter. The circuit comprising a comparator configured to receive, at a first input terminal of the comparator, a reverse current sensing signal during a conduction phase of the high-side switch, the reverse current sensing signal corresponding to a reverse current flowing at the high-side switch during the conduction phase; receive, at a second input terminal of the comparator, a threshold; generating an output signal based on a comparison between the reverse current sensing signal and the threshold; a multiplexer configured to select between a first input signal and a second input signal based on the output signal of the comparator, the first input signal corresponding to a first dead time duration between turning OFF the high-side switch and turning on the low-side switch, the second input signal corresponding to a second dead time duration between turning OFF the high-side switch and turning ON the low-side switch of the active clamp flyback converter, the first dead time duration being a function of a reverse recovery time of a body diode of the low-side switch; and a monostable multivibrator configured to set a time duration between turning OFF the high-side switch and turning ON the low-side switch of the active clamp flyback converter based on an output of the multiplexer.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a schematic of an embodiment active clamp flyback converter;

FIG. 2 shows the impact on the current at the high side of the active clamp flyback converter in the case of a short circuit on the secondary winding of transformer, or across the secondary rectifier;

FIG. 3 is a schematic of an embodiment circuit for short circuit protection in an active clamp flyback converter;

FIG. 4 is a plot for a short circuit on the secondary winding of transformer without the circuit of FIG. 3;

FIG. 5 is a plot, which provides a qualitative representation of how the reverse recovery time may vary and, in some instances, exceed the duration of the low-side conduction time for a short circuit on the secondary winding of transformer without the circuit of FIG. 3;

FIG. 6 is a plot for the operation of the active clamp flyback converter with the circuit of FIG. 3, where the dead time is enlarged in response to the overcurrent protection on the high side being triggered; and

FIG. 7 is a flow chart of an embodiment method for operating the circuit of FIG. 3 in a controller of the active clamp flyback converter.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

Generally, in an active clamp flyback converter, a reverse current (I_{REV}) flows on the primary side of the transformer when the main switch of the active clamp flyback converter is in the OFF state. The reverse current helps deplete a drain capacitance of the active clamp circuit before the main switch is turned ON to achieve soft-switching (i.e., ZVS).

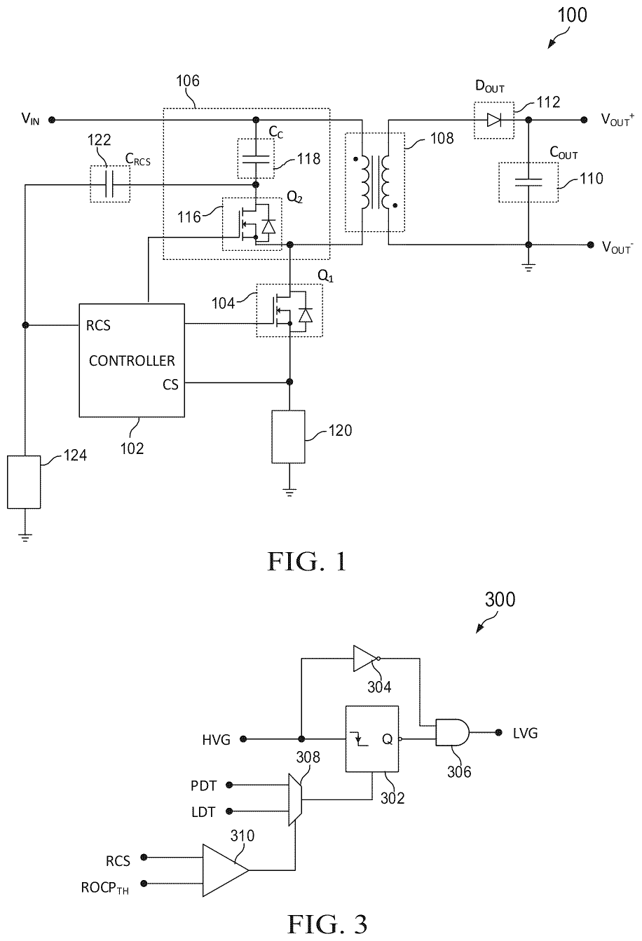

FIG. 1 illustrates a schematic of an embodiment active clamp flyback converter 100. Active clamp flyback converter 100 includes a controller 102, a low-side switch (Q₁) 104, an active clamp 106, a transformer 108, an output capacitor (C_{OUT}) 110, an output diode (D_{OUT}) 112, a first sense resistor 120, a sense capacitor (C_{RCS}) 122, and a second sense resistor 124, which may (or may not) be arranged as shown. Active clamp 106 includes a clamp capacitor (C_{C}) 118 and a high-side switch (Q₂) 116 (i.e., auxiliary switch). Active clamp flyback converter 100 may include additional components not shown, such as a load at the output or an optional clamp resistor arranged in parallel with the clamp capacitor (C_{C}) 118.

Controller 102 dictates the precise timing and duration for the low-side switch (Q₁) 104 and the high-side switch (Q₂) 116. By coordinating the operation of both switches, Controller 102 ensures efficient energy transfer and regulates the output voltage (V_{OUT}) or current. Controller 102 drives the low-side switch (Q₁) 104, turning it ON and OFF at a specific frequency and duty cycle.

When the low-side switch (Q₁) 104 is turned ON, energy is stored in the primary winding of the transformer 108. When the low-side switch (Q₁) 104 is turned OFF, this stored energy is transferred to the secondary winding of the transformer 108 and then to the output. In embodiments, the low-side switch (Q₁) 104 is a metal-oxide-semiconductor field-effect transistor (MOSFET).

The transformer 108 provides electrical isolation between the input voltage (V_{IN}) and the output voltage (V_{OUT}). It also stores energy during the ON state of the low-side switch (Q₁) 104 (in its primary winding) and releases it to the load of the standard flyback converter during the OFF state of the low-side switch (Q₁) 104 (i.e., through its secondary winding).

In embodiments, the input voltage (V_{IN}) is an AC voltage between 210 and 230 volts. In embodiments, the input voltage (V_{IN}) is an AC voltage between 110 and 130 volts.

The output capacitor (C_{OUT}) 110 is located after the second winding of the transformer 108. It filters out the high-frequency switching ripple, ensuring a stable and smooth DC output voltage (V_{OUT}). Energy storage also provides instantaneous power to the load during transient conditions.

The output diode (D_{OUT}) 112 allows current to flow from the secondary winding of the transformer 108 to the output during the OFF phase of the low-side switch (Q₁) 104 and blocks current during the ON phase, ensuring unidirectional current flow at the output.

The active clamp 106 recycles the energy stored in the leakage inductance of the transformer 108, reducing voltage spikes and improving efficiency. The high-side switch (Q₂) 116 provides a controlled path for this energy, while the clamp capacitor (C_{C}) 118 temporarily stores and releases the energy. In embodiments, the high-side switch (Q₂) 116 is a MOSFET.

Operationally, when the low-side switch (Q₁) 104 is activated, the current flows into the primary winding of the transformer 108, storing energy. Upon deactivating the low-side switch (Q₁) 104, the energy moves to the secondary winding due to the collapsing magnetic field. It is then channeled to the output via the output diode (D_{OUT}) 112.

Simultaneously, in a complementary control setup, the high-side switch (Q₂) 116 in the active clamp 106 is turned ON, providing a pathway for any excess energy (from the transformer's leakage inductance) to the clamp capacitor (C_{C}) 118, thus preventing harmful voltage spikes. This active clamp operation enhances efficiency and prolongs the life of components.

Controller 102 synchronizes the operation of the low-side switch (Q₁) 104 and the high-side switch (Q₂) 116 to maintain a regulated output. In embodiments, in a non-complementary control setup, the clamp capacitor (C_{C}) 118 is charged via the body diode (not shown) of the high-side switch (Q₂) 116 regardless of whether the high-side switch (Q₂) 116 is in the OFF state.

In embodiments, the capacitance of the clamp capacitor (C_{C}) 118 is in the hundreds of nanoFarads (nF). In embodiments, the capacitance of the clamp capacitor (C_{C}) 118 ranges between 100 to 500 nF.

Despite the increased complexity of the active clamp flyback converter 100, mainly because of the driving needs of the high-side switch (Q₂) 116, it has the benefit of utilizing the energy from leakage inductance to attain soft-switching (i.e., ZVS) for the low-side switch (Q₁) 104 and high-side switch (Q₂) 116. The active clamp flyback converter 100 can reach an efficiency of over 93% even at high switch frequencies beyond 100 kHz. It also produces smooth waveforms with minimal electromagnetic interference.

The first sense resistor 120, which can be implemented as a standard shunt resistor, senses current on the low-side switch (Q₁) 104, with its voltage conveyed to a dedicated current sense (CS) pin of controller 102. When the monitored current at the current sense (CS) pin suppresses a first predetermined threshold, the conduction at the low-side switch (Q₁) 104 is terminated.

In embodiments, the capacitance of the sense capacitor (C_{RCS}) 122 is 1/1000 the capacitance of the clamp capacitor (C_{C}) 118. In embodiments, the capacitance of the sense capacitor (C_{RCS}) 122 ranges between 100 to 500 picoFarads. In embodiments, the resistance of the second sense resistor 124 ranges between 100 to 150 ohms.

The second sense resistor 124 and the sense capacitor (C_{RCS}) 122 form a capacitive current divider to infer the reverse current that flows at the high-side switch (Q₂) 116 during the discharge phase of the active clamp 106. The voltage that develops across the second sense resistor 124 is transmitted to a reverse current sense (RCS) pin of controller 102. When the monitored current at the reverse current sense (RCS) pin exceeds a second predetermined threshold, the conduction at the high-side switch (Q₂) 116 is terminated.

The configuration closely resembles a half-bridge and is insufficient in addressing certain issues. Specifically, if the conduction through the high-side switch (Q₂) 116 is interrupted during short circuits, the current continues to recirculate through the body diode of the low-side switch (Q₁) 104. As the short circuit condition persists, the conduction of the low-side switch (Q₁) 104 is also interrupted quickly.

However, while the current travels through the body diode of the low-side switch (Q₁) 104, after a dead time, the low-side switch (Q₁) 104 is activated, leading to an almost immediate deactivation of the body diode. This rapid switching does not afford the body diode sufficient time to recombine the charges within the junction. When the low-side switch (Q₁) 104 is then turned OFF, allowing the drain voltage to rise to a high voltage at a steep rate (high dv/dt), the body diode is unable to withstand these voltages, destroying the low-side switch (Q₁) 104. This sequence of events, and transfer of current, leads to the failure of both switches.

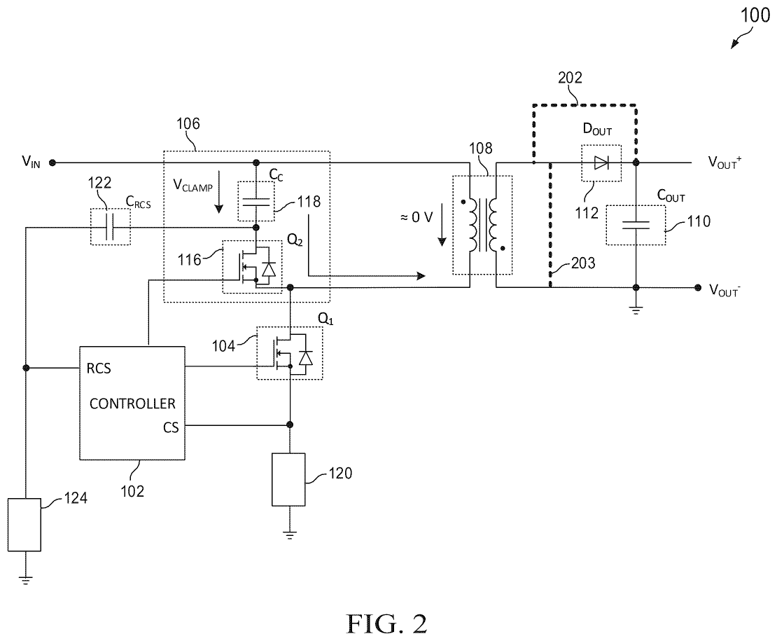

FIG. 2 illustrates the impact on the current at the high side of the active clamp flyback converter 100 in the case of a short circuit occurring at the secondary side of transformer 108. As discussed above, with respect to FIG. 1, the early termination of the conduction at the low-side switch (Q₁) 104 or the high-side switch (Q₂) 116 is a protective measure for the active clamp flyback converter 100 and the load to which it is supplying the output voltage (V_{OUT}).

However, under specific conditions, such as a short circuit in the secondary winding of transformer 108 or across the secondary rectifier, the protective strategy outlined above may not prevent the low-side switch (Q₁) 104 or the high-side switch (Q₂) 116 from suffering catastrophic failure.

For example, when a short circuit 202 involves the secondary rectifier, a continuous output voltage is applied at the secondary side, which is reflected onto the primary side—effectively bypassing the primary inductance. The output and reflected voltages decrease proportionally to the values of the output capacitor (C_{OUT}) 110 and load resistance. In a typical situation, the switching activity of the active clamp flyback converter 100 is suspended until the output voltage (V_{OUT}) diminishes to a low level (≅0 V), a precautionary step to prevent the active clamp flyback converter 100 from operating in continuous current mode (CCM).

Suppose the short circuit 203 is directly on the secondary winding of transformer 108. The reflected voltage starts substantially low when the high-side switch (Q₂) 116 is initially switched on. In that case, it activates reverse over-current protection because the clamp voltage (i.e., the voltage (V_{CLAMP}) across the clamp capacitor (C_{C}) 118) is predominantly exerted on the leakage inductance of transformer 108. In the ensuing dead time before the activation of the low-side switch (Q₁) 104, a high reverse current discharges through the drain capacitor of the low-side switch (Q₁) 104 and passes through its body diode.

Upon conclusion of this dead time and with the low-side switch (Q₁) 104 turned ON, the input voltage gets applied directly to the leakage inductance of transformer 108, leading to a rapid increase in current. This surge continues unabated until over-current protection is triggered by a high voltage detected at the current sense (CS) pin, causing an immediate cessation of conduction.

Should this conduction duration be shorter than the reverse recovery time of the body diode, there's a risk that the diode will fail to withstand the applied high voltage at the turn-OFF the low-side switch (Q₁) 104, potentially leading to catastrophic failure of the device. In particular, if residual charges remain in the junction when the low-side switch (Q₁) 104 is switched OFF, the steep rise in voltage (represented as high dv/dt) may inadvertently activate the device's parasitic bipolar junction transistor—this unwanted scenario could spell disaster for the low-side switch (Q₁) 104.

Accordingly, in the case of a short circuit on the secondary side of the transformer 108, or if a rectifier on the secondary side experiences a short circuit, the inductance at the transformer's primary side is shunted and effectively at zero volts. Under these conditions, the current will flow from the clamp capacitor (C_{C}) 118—which acts akin to a battery due to its relatively large size when compared to the sense capacitor (C_{RCS}) 122—establishing the voltage of the clamp capacitor (C_{C}) 118 as though it were a voltage generator. With no inductance to impede the flow at the primary side of the transformer 108, and disregarding minor resistances from parasitic and the low on-resistance (R_DS(on)) of the high-side switch (Q₂) 116, the only significant restriction to the current flow is the transformer's leakage inductance; this leakage inductance constitutes just a small fraction of the primary side's main inductance.

Consequently, an exceedingly high current will surge through the loop that comprises the clamp capacitor (C_{C}) 118, the high-side switch (Q₂) 116, and transformer leakage inductance. This surge can be detected at the reverse current sense (RCS) pin of controller 102. Upon actuation of the controller's internal comparator, the high-side switch (Q₂) 116 is shut down. Once deactivated, the high-side switch (Q₂) 116 no longer provides a path for current flow, forcing the current to flow through the body diode of the now-OFF low-side switch (Q₁) 104, which will endure a substantially high current passing through it.

FIG. 3 illustrates a schematic of an embodiment circuit 300 for short circuit protection in an active clamp flyback converter, such as the active clamp flyback converter 100. Circuit 300 includes a monostable multivibrator 302, an inverter 304, an AND gate 306, a multiplexer 308, and a comparator 310, which may (or may not) be arranged as shown. Circuit 300 may include additional components that are not shown, such as a controller and memory. In embodiments, circuit 300 may be implemented in controller 102. In embodiments, circuit 300 may be implemented outside of controller 102.

The monostable multivibrator 302, or a one-shot pulse generator, is configured to generate a high logic level output in its stable state. When triggered, the monostable multivibrator 302 transitions to a logic level low for a duration—known as the pulse width or time constant. The output of the monostable multivibrator 302 stays at the low logic level until the time delay has elapsed when it returns to its stable state, and its output transitions to the high logic level.

The trigger signal for the monostable multivibrator 302 is the high-side control signal (HVG) for the high-side switch (Q₂) 116 provided by controller 102. Accordingly, in embodiments, the monostable multivibrator 302 is coupled to the output of the controller 102.

Specifically, in an embodiment, the monostable multivibrator 302 is configured to be triggered at the negative edge of the high-side control signal (HVG) for the high-side switch (Q₂) 116—corresponding to the turning OFF the high-side switch (Q₂) 116. Monostable multivibrator 302 produces a negative pulse with the duration corresponding to the desired dead time for the low-side switch (Q₁) 104.

The output of the monostable multivibrator 302 is provided to the first input of the AND gate 306. The second input of the AND gate 306 is coupled to an inverted signal of the control signal for the high-side switch (Q₂) 116 through the inverter 304.

The output of the AND gate 306 is provided as the low-side control signal (LVG) for the low-side switch (Q₁) 104. When the high-side switch (Q₂) 116 is turned OFF (i.e., the high-side control signal (HVG) for the high-side switch (Q₂) 116 is at a logic level low) and after the duration elapses immediately after the high-side switch (Q₂) 116 is turned OFF, the low-side control signal (LVG) is at a high logic level and the low-side switch (Q₁) 104 is turned ON. Thus, the low-side switch (Q₁) 104 is turned ON only after the duration has elapsed immediately after the high-side switch (Q₂) 116 is turned OFF.

The multiplexer 308 is configured to produce a control signal fed to the monostable multivibrator 302 to set the dead time duration for the monostable multivibrator 302. Specifically, the output of the multiplexer 308 is one of two signals: a programmed dead time (PDT) signal or a long dead time (LDT) signal. Based on the output of the comparator 310, multiplexer 308 is configured to forward one of these two signals to the monostable multivibrator 302 to set the dead time duration before turning on the low-side switch (Q₁) 104 immediately after the high-side switch (Q₂) 116 is turned OFF. The PDT signal corresponds to the normal condition, which is defined by, for example, controller 102. The LDT signal corresponds to the case where the reverse overcurrent protection is triggered.

The comparator 310 has the first input coupled to the reverse current sense (RCS) pin of controller 102. As discussed previously, the reverse current sense (RCS) pin receives the reverse current sensing signal during the conduction of the high-side switch (Q₂) 116 (i.e., when the high-side switch (Q₂) 116 is turned ON). The second input of the comparator 310 is coupled to a reverse overcurrent protection threshold (ROCP_{TH}).

In response to the reverse current sensing signal during the conduction of the high-side switch (Q₂) 116 exceeding the reverse overcurrent protection threshold (ROCP_{TH}), the reverse overcurrent protection is triggered. The comparator 310 provides a signal to the multiplexer 308 such that the multiplexer 308 forwards the LDT signal to the monostable multivibrator 302. This results in the dead time (i.e., the time between the turning OFF the high-side switch (Q₂) 116 and the turning ON the low-side switch (Q₁) 104) being extended to the duration set by the LDT signal.

Conversely, in response to the reverse current sensing signal during the conduction of the high-side switch (Q₂) 116 falling below the reverse overcurrent protection threshold (ROCP_{TH}), the active clamp flyback converter 100 operates normally. The comparator 310 provides a signal to the multiplexer 308 such that the multiplexer 308 forwards the PDT signal to the monostable multivibrator 302. This results in the dead time (i.e., the time between the turning OFF the high-side switch (Q₂) 116 and the turning ON the low-side switch (Q₁) 104) to equal the duration set by the PDT signal.

In embodiments, the duration of the long dead time (LDT) signal corresponds to the reverse recovery time of the body diode of the low-side switch (Q₁) 104. In embodiments, the duration of the long dead time (LDT) signal is programable. In embodiments, the duration of the long dead time (LDT) signal is approximately 1 microsecond. In embodiments, the duration of the programmed dead time (PDT) signal is between 100 to 500 nanoseconds.

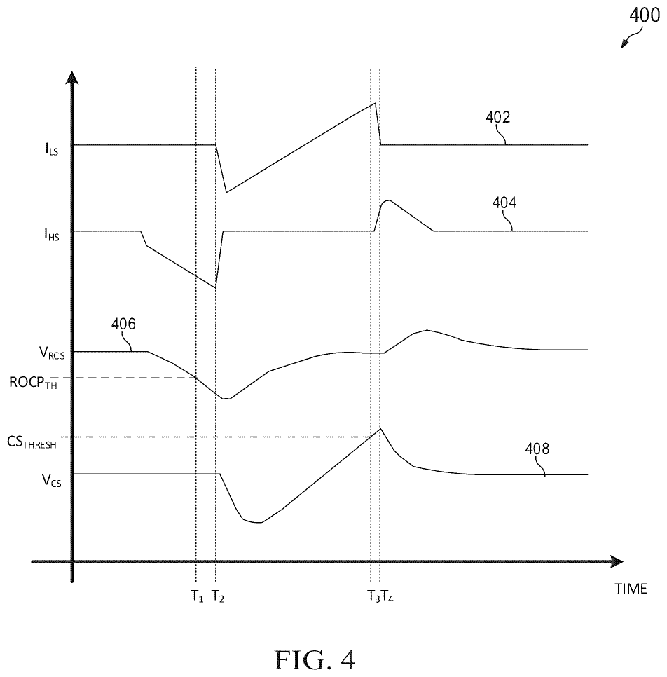

FIG. 4 illustrates plot 400 for a short circuit on the secondary winding of transformer 108 without circuit 300 in the active clamp flyback converter 100 and corresponding to FIG. 2.

Plot 400 includes the low-side current (I_{LS}) 402, the high-side current (I_{HS}) 404, the reverse current sense voltage (V_{RCS}) at the reverse current sense (RCS) pin, and the sense current voltage (V_{CS}) 408 at the current sense (CS) pin.

In response to the reverse current sense voltage (V_{RCS}) at the reverse current sense (RCS) pin falling below the reverse overcurrent protection threshold (ROCP_{TH}), controller 102 turns OFF the high-side switch (Q₂) 116 at time T₁. However, due to a first internal protection delay, the high-side switch (Q₂) 116 is not turned OFF until time T₂.

For example, in response to the high-side current (I_{HS}) 404 exceeding 10 amps, the overcurrent protection is triggered, which turns OFF the high-side switch (Q₂) 116 at time T₁. However, due to the first internal protection delay and the high slope of the high-side current (I_{HS}) 404, the high-side current (I_{HS}) 404 continues to go further than 10 amps until time T₂.

In embodiments, the reverse overcurrent protection threshold (ROCP_{TH}) is between 0.4 and 0.6 volts. In an embodiment, the reverse overcurrent protection threshold (ROCP_{TH}) is 0.5 volts.

In embodiments, controller 102 includes a comparator circuit that compares the reverse current sense voltage (V_{RCS}) at the reverse current sense (RCS) pin with the overcurrent protection threshold (ROCP_{TH}). In response to the reverse current sense voltage (V_{RCS}) at the reverse current sense (RCS) pin exceeding the overcurrent protection threshold (ROCP_{TH}), the high-side switch (Q₂) 116 is turned OFF.

Once at time T₂, the high-side switch (Q₂) 116 is turned OFF, the low-side current (I_{LS}) 402 begins through the body diode of the low-side switch (Q₁) 104. At time T₃, in response to the sense current voltage (V_{CS}) 408 at the current sense (CS) pin exceeding the current sense threshold (CS_{THRESH}), the low-side switch (Q₁) 104 turns OFF. Similar to the high-side switch (Q₂) 116, the low-side switch (Q₁) 104 is not turned OFF until after a second internal protection delay at time T₄.

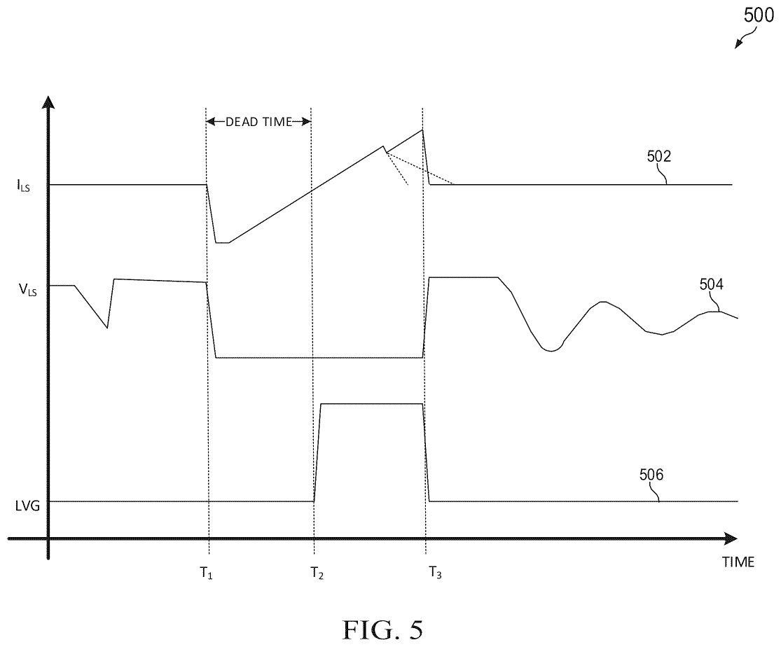

FIG. 5 illustrates plot 500, which provides a qualitative representation of how the reverse recovery time may vary and, in some instances, exceed the duration of the low-side conduction time for a short circuit on the secondary winding of transformer 108 without circuit 300 in the active clamp flyback converter 100, corresponding to FIG. 2.

Plot 500 includes the low-side current (I_{LS}) 502, the low-side voltage (V_{LS}) 504, and the low-side control signal (LVG) 506. A dead-time is introduced between time T₁ and time T₂ before transitioning the low-side switch (Q₁) 104 from a logic low signal to a logic high signal.

The low-side conduction time (i.e., low-side control signal (LVG) 506 being at a logic high signal) can be diminished due to the activation of overcurrent protection mechanisms. The low-side current (I_{LS}) 502 can rapidly escalate to several amperes in such scenarios. With an equivalent drain capacitance within a few hundred picofarads range, the drain terminal of the low-side switch (Q₁) 104 is vulnerable to a voltage change rate (dv/dt) extending into tens of volts per nanosecond upon turn-OFF. Should the reverse recovery process still be underway at this juncture, the voltage change rate (dv/dt) can pose a significant risk to the transistor's integrity of the low-side switch (Q₁) 104.

During the programmable or fixed dead time interval (time between the high-side switch (Q₂) 116 is turned OFF and the low-side switch (Q₁) 104 is turned ON), a considerably large low-side current (I_{LS}) 502 is conducted through the body diode of the low-side switch (Q₁) 104. Furthermore, the body diode of the low-side switch (Q₁) 104 undergoes a reverse recovery while conducting. This reverse recovery process must be completed before the cessation of conduction. In embodiments, the programmable or fixed dead time interval is between 100 and 200 nanoseconds.

If the process is unfinished before turning OFF the low-side switch (Q₁) 104, there is a risk that the diode will fail to block a rising high voltage. Such a failure can result in a short circuit within the low-side switch (Q₁) 104. The relatively low reverse voltage during the channel's conduction period also adversely prolongs the reverse recovery time.

The introduction of dead time, which is the duration required for the voltage at the low-side switch to fall to zero, is contingent upon the low-side current (I_{LS}) 502 at the low-side switch (Q₁) 104. If the low-side current (I_{LS}) 502 at the drain of the low-side switch (Q₁) 104 is considerable, a reduced dead time is necessary, as the voltage will reach zero more rapidly. Specifically, in the event of a short circuit, a minimal dead time is anticipated because it is expected that the drain voltage of the low-side switch (Q₁) 104 will decline to zero faster. Accordingly, the dead time is shortened in response to the overcurrent protection in the event of the short circuit.

When the dead time is shortened and the low-side switch (Q₁) 104 is turned ON immediately, the low-side current (I_{LS}) 502 continues to rise. Initially, the low-side current (I_{LS}) 502 flows through the body diode of the low-side switch (Q₁) 104, which can be considerable. To turn OFF the body diode of the low-side switch (Q₁) 104, it is beneficial to let the low-side current (I_{LS}) 502 increase slightly further to account for the reverse charges and ensure that the current diminishes to zero, as the current must reverse direction for the diode to be effectively turned OFF. The time it takes to turn OFF the diode is influenced by the magnitude of reverse voltage.

If the low-side switch (Q₁) 104 is activated, the reverse voltage across the body diode remains low because the current is channeled into the low-side switch (Q₁) 104, resulting in a minimal voltage drop. As a result, before time T₂—which marks when the low-side switch (Q₁) 104 is activated-the low-side current (I_{LS}) 502 continues to circulate through the body diode. However, when the low-side switch (Q₁) 104 is turned ON at time T₂, the transition of current from the diode to the low-side switch (Q₁) 104 isn't instantaneous, and the charging of the junction's reverse charges delays its reduction, particularly because of the relatively small voltage across the low-side switch (Q₁) 104.

If overcurrent protection persists when the low-side switch (Q₁) 104 is activated, the current doesn't flow through the loop containing the clamp capacitor (C_{C}) 118, the high-side switch (Q₂) 116, and the leakage inductance of transformer 108, but rather continues along its path towards the low-side switch (Q₁) 104 at a similar rate, limited only by the leakage inductance.

During the limited duration when the low-side switch (Q₁) 104 remains on (between time T₂ and time T₃), where the low-side control signal (LVG) 506 is at a high logic level, the low-side voltage (V_{LS}) 504 escalates sharply at time T₃ when the low-side switch (Q₁) 104 is deactivated, charging capacitance rapidly. Should the body diode of the low-side switch (Q₁) 104 not fully recover by this point, it is prone to breakdown. If its reverse recovery time is not completed before time T₃, then immediately after the low-side switch (Q₁) 104 is turned OFF and the voltage spikes, it could lead to breakdown and the potential destruction of the low-side switch (Q₁) 104 through activating its internal parasitic bipolar junction.

In light of these considerations, allowing for a longer body diode reverse recovery time during short circuit conditions would be advantageous to prevent such failures, which would be contrary to the conventional solution for overcurrent protection.

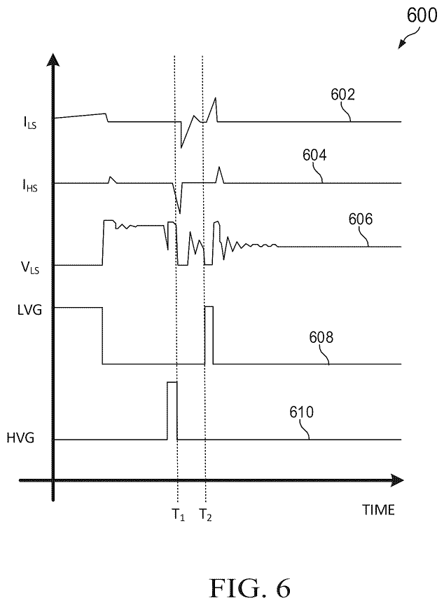

FIG. 6 illustrates plot 600 for the operation of the active clamp flyback converter 100 with circuit 300, where the dead time is enlarged in response to the overcurrent protection on the high side being triggered.

Plot 600 includes the low-side current (I_{LS}) 602, the high-side current (I_{HS}) 604, the low-side voltage (V_{LS}) 606, the low-side control signal (LVG) 608, and the high-side control signal (HVG) 610.

In response to the reverse current sensing signal during the conduction of the high-side switch (Q₂) 116 exceeding the reverse overcurrent protection threshold (ROCP_{TH}), the reverse overcurrent protection is triggered. This results in the dead time (i.e., the time between the turning OFF the high-side switch (Q₂) 116 and the turning ON the low-side switch (Q₁) 104) being extended from time T₁ until time T₂.

The high-side control signal (HVG) 610 and the low-side control signal (LVG) 608 are commands designated for the high-side switch (Q₂) 116 and low-side switch (Q₁) 104 (i.e., the respective driver feeding the control terminal of the switches), respectively.

In embodiments, a monostable multivibrator within the circuit 300 is activated by the falling edge of the high-side control signal (HVG) 610, corresponding to the moment when the high-side switch (Q₂) 116 turns OFF. This activation generates a negative pulse, the duration of which is predetermined to be the dead time. Once this dead time has lapsed, the low-side control signal (LVG) 608 can be set to high, allowing for the subsequent activation of the low-side switch (Q₁) 104. The duration of the dead time is determined by the multiplexer which is fed by two distinct inputs: firstly, the programmed dead time (PDT), which is the standard interval set under normal conditions by the controller; and secondly, the long dead time (LDT), which is selected when reverse overcurrent protection is initiated.

In embodiments, the monitored current (or representation of the current) at the reverse current sense (RCS) pin, pertinent to the high-side conduction phase, is measured at the RCS pin and compared to the reverse current sense threshold (RCS_{THRESH}). Under standard operational conditions, the dead time aligns with the PDT value. Conversely, in reverse overcurrent protection scenarios, the dead time extends to match the LDT value to ensure proper protection and system functionality.

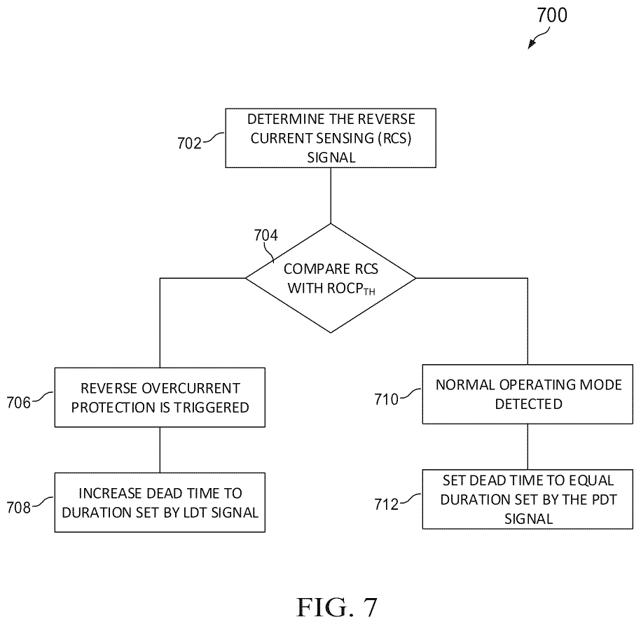

FIG. 7 illustrates a flow chart of an embodiment method 700 for operating circuit 300 in controller 102 of the active clamp flyback converter 100. It is noted that all steps outlined in the flow chart of method 700 are not necessarily required and can be optional. Further, changes to the arrangement of the steps, removal of one or more steps and path connections, and addition of steps and path connections are similarly contemplated.

At step 702, the reverse current sensing (RCS) signal is sensed during the conduction of the high-side switch (Q₂) 116. In embodiments, the second sense resistor 124 and the sense capacitor (C_{RCS}) 122 form a capacitive current divider to infer the reverse current that flows at the high-side switch (Q₂) 116 during the discharge phase of the active clamp 106.

At step 704, the reverse current sensing (RCS) signal is compared to the reverse overcurrent protection threshold (ROCP_{TH}). Circuit 300 operates in two modes: the reverse overcurrent protection mode and the normal operating mode.

At step 706, the reverse overcurrent protection is triggered in response to the reverse current sensing (RCS) signal during the conduction of the high-side switch (Q₂) 116 exceeding the reverse overcurrent protection threshold (ROCP_{TH}).

At step 708, in response to the reverse overcurrent protection mode triggering, comparator 310 provides a signal to the multiplexer 308 such that the multiplexer 308 forwards the LDT signal to the monostable multivibrator 302. This results in the dead time (i.e., the time between the turning OFF the high-side switch (Q₂) 116 and the turning ON the low-side switch (Q₁) 104) being extended to the duration set by the LDT signal.

At step 710, in response to the reverse current sensing signal during the conduction of the high-side switch (Q₂) 116 falling below the reverse overcurrent protection threshold (ROCP_{TH}), the active clamp flyback converter 100 operates normally.

At step 712, in response to detecting the normal operating mode, comparator 310 provides a signal to the multiplexer 308 such that the multiplexer 308 forwards the PDT signal to the monostable multivibrator 302. This results in the dead time (i.e., the time between the turning OFF the high-side switch (Q₂) 116 and the turning ON the low-side switch (Q₁) 104) to equal the duration set by the PDT signal.

These steps are repeated for subsequent operating cycles of the active clamp flyback converter 100.

A first aspect relates to a method for operating an active clamp flyback converter. The method comprises sensing a reverse current sensing signal during a conduction phase of a high-side switch of the active clamp flyback converter, the reverse current sensing signal corresponding to a reverse current flowing at the high-side switch during the conduction phase; comparing the reverse current sensing signal to a threshold; setting a first dead time duration between turning OFF the high-side switch and turning ON a low-side switch of the active clamp flyback converter in response to the reverse current sensing signal exceeding the threshold, the first dead time duration being a function of a reverse recovery time of a body diode of the low-side switch; and setting a second dead time duration between turning OFF the high-side switch and turning ON the low-side switch of the active clamp flyback converter in response to the reverse current sensing signal falling below the threshold, the second dead time duration being less than the first dead time duration.

In a first implementation form of the method according to the first aspect as such, sensing the reverse current sensing signal comprises sensing the reverse current flowing at the high-side switch through a capacitive current divider formed by a sense resistor and a sense capacitor coupled to the high-side switch.

In a second implementation form of the method according to the first aspect as such or any preceding implementation form of the first aspect, a monostable multivibrator is configured to generate a dead time between turning OFF the high-side switch and turning ON the low-side switch corresponding to the first dead time duration or the second dead time duration based on a comparison of the reverse current sensing signal to the threshold.

In a third implementation form of the method according to the first aspect as such or any preceding implementation form of the first aspect, a trigger signal for the monostable multivibrator is a high-side control signal to control an operation of the high-side switch.

In a fourth implementation form of the method according to the first aspect as such or any preceding implementation form of the first aspect, the monostable multivibrator is configured to be triggered at a negative edge of the high-side control signal.

In a fifth implementation form of the method according to the first aspect as such or any preceding implementation form of the first aspect, the monostable multivibrator is configured to generate a negative pulse with a duration corresponding to the first dead time duration or the second dead time duration based on a comparison of the reverse current sensing signal to the threshold.

In a sixth implementation form of the method according to the first aspect as such or any preceding implementation form of the first aspect, the method further comprises generating a low-side control signal for operating the low-side switch based on the negative pulse generated by the monostable multivibrator and the high-side control signal.

A second aspect relates to a circuit for overcurrent protection in an active clamp flyback converter. The circuit comprising a comparator configured to receive, at a first input terminal of the comparator, a reverse current sensing signal during a conduction phase of a high-side switch of the active clamp flyback converter, the reverse current sensing signal corresponding to a reverse current flowing at the high-side switch during the conduction phase; receive, at a second input terminal of the comparator, a threshold; generating an output signal based on a comparison between the reverse current sensing signal and the threshold; a multiplexer configured to select between a first input signal and a second input signal based on the output signal of the comparator, the first input signal corresponding to a first dead time duration between turning OFF the high-side switch and turning ON a low-side switch of the active clamp flyback converter, the second input signal corresponding to a second dead time duration between turning OFF the high-side switch and turning ON the low-side switch of the active clamp flyback converter; and a monostable multivibrator configured to set a time duration between turning OFF the high-side switch and turning ON the low-side switch of the active clamp flyback converter based on an output of the multiplexer.

In a first implementation form of the circuit according to the second aspect as such, sensing the reverse current sensing signal comprises sensing the reverse current flowing at the high-side switch through a capacitive current divider formed by a sense resistor and a sense capacitor coupled to the high-side switch.

In a second implementation form of the circuit according to the second aspect as such or any preceding implementation form of the second aspect, the first dead time duration is a function of a reverse recovery time of a body diode of the low-side switch.

In a third implementation form of the circuit according to the second aspect as such or any preceding implementation form of the second aspect, an input to the monostable multivibrator is a high-side control signal coupled to a control terminal of the high-side switch, the circuit further comprising an inverter configured to generate an inverted signal of the high-side control signal; and an AND gate having a first input coupled to an output of the inverter, a second input of the AND gate coupled to an output of the monostable multivibrator, and an output of the AND gate coupled to a control terminal of the low-side switch.

In a fourth implementation form of the circuit according to the second aspect as such or any preceding implementation form of the second aspect, a trigger signal for the monostable multivibrator is a high-side control signal to control an operation of the high-side switch.

In a fifth implementation form of the circuit according to the second aspect as such or any preceding implementation form of the second aspect, the monostable multivibrator is configured to be triggered at a negative edge of the high-side control signal.

In a sixth implementation form of the circuit according to the second aspect as such or any preceding implementation form of the second aspect, the monostable multivibrator is configured to generate a negative pulse with a duration corresponding to the first dead time duration or the second dead time duration based on the output of the multiplexer.

A third aspect relates to a system. The system comprising an active clamp flyback converter comprising a high-side switch and a low-side switch; and a circuit configured for overcurrent protection of the active clamp flyback converter. The circuit comprising a comparator configured to receive, at a first input terminal of the comparator, a reverse current sensing signal during a conduction phase of the high-side switch, the reverse current sensing signal corresponding to a reverse current flowing at the high-side switch during the conduction phase; receive, at a second input terminal of the comparator, a threshold; generating an output signal based on a comparison between the reverse current sensing signal and the threshold; a multiplexer configured to select between a first input signal and a second input signal based on the output signal of the comparator, the first input signal corresponding to a first dead time duration between turning OFF the high-side switch and turning ON the low-side switch, the second input signal corresponding to a second dead time duration between turning OFF the high-side switch and turning ON the low-side switch of the active clamp flyback converter, the first dead time duration being a function of a reverse recovery time of a body diode of the low-side switch; and a monostable multivibrator configured to set a time duration between turning OFF the high-side switch and turning ON the low-side switch of the active clamp flyback converter based on an output of the multiplexer.

In a first implementation form of the system according to the third aspect as such, the active clamp flyback converter further comprises a sense resistor and a sense capacitor coupled to the high-side switch, wherein sensing the reverse current sensing signal comprises sensing the reverse current flowing at the high-side switch through a capacitive current divider formed by the sense resistor and the sense capacitor.

In a second implementation form of the system according to the third aspect as such or any preceding implementation form of the third aspect, an input to the monostable multivibrator is a high-side control signal coupled to a control terminal of the high-side switch, the circuit further comprising an inverter configured to generate an inverted signal of the high-side control signal; and an AND gate having a first input coupled to an output of the inverter, a second input of the AND gate coupled to an output of the monostable multivibrator, and an output of the AND gate coupled to a control terminal of the low-side switch.

In a third implementation form of the system according to the third aspect as such or any preceding implementation form of the third aspect, a trigger signal for the monostable multivibrator is a high-side control signal to control an operation of the high-side switch.

In a fourth implementation form of the system according to the third aspect as such or any preceding implementation form of the third aspect, the monostable multivibrator is configured to be triggered at a negative edge of the high-side control signal.

In a fifth implementation form of the system according to the third aspect as such or any preceding implementation form of the third aspect, the monostable multivibrator is configured to generate a negative pulse with a duration corresponding to the first dead time duration or the second dead time duration based on the output of the multiplexer.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method for operating an active clamp flyback converter, the method comprising:
sensing a reverse current sensing signal during a conduction phase of a high-side switch of the active clamp flyback converter, the reverse current sensing signal corresponding to a reverse current flowing at the high-side switch during the conduction phase;
comparing the reverse current sensing signal to a threshold;
setting a first dead time duration between turning OFF the high-side switch and turning ON a low-side switch of the active clamp flyback converter in response to the reverse current sensing signal exceeding the threshold, the first dead time duration being a function of a reverse recovery time of a body diode of the low-side switch; and
setting a second dead time duration between turning OFF the high-side switch and turning ON the low-side switch of the active clamp flyback converter in response to the reverse current sensing signal falling below the threshold, the second dead time duration being less than the first dead time duration.

2. The method of claim 1, wherein sensing the reverse current sensing signal comprises sensing the reverse current flowing at the high-side switch through a capacitive current divider formed by a sense resistor and a sense capacitor coupled to the high-side switch.

3. The method of claim 1, wherein a monostable multivibrator is configured to generate a dead time between turning OFF the high-side switch and turning ON the low-side switch corresponding to the first dead time duration or the second dead time duration based on a comparison of the reverse current sensing signal to the threshold.

4. The method of claim 3, wherein a trigger signal for the monostable multivibrator is a high-side control signal to control an operation of the high-side switch.

5. The method of claim 4, wherein the monostable multivibrator is configured to be triggered at a negative edge of the high-side control signal.

6. The method of claim 5, wherein the monostable multivibrator is configured to generate a negative pulse with a duration corresponding to the first dead time duration or the second dead time duration based on a comparison of the reverse current sensing signal to the threshold.

7. The method of claim 6, further comprising generating a low-side control signal for operating the low-side switch based on the negative pulse generated by the monostable multivibrator and the high-side control signal.

8. A circuit for overcurrent protection in an active clamp flyback converter, the circuit comprising:
a comparator configured to:
receive, at a first input terminal of the comparator, a reverse current sensing signal during a conduction phase of a high-side switch of the active clamp flyback converter, the reverse current sensing signal corresponding to a reverse current flowing at the high-side switch during the conduction phase;
receive, at a second input terminal of the comparator, a threshold;
generating an output signal based on a comparison between the reverse current sensing signal and the threshold;
a multiplexer configured to select between a first input signal and a second input signal based on the output signal of the comparator, the first input signal corresponding to a first dead time duration between turning OFF the high-side switch and turning ON a low-side switch of the active clamp flyback converter, the second input signal corresponding to a second dead time duration between turning OFF the high-side switch and turning ON the low-side switch of the active clamp flyback converter; and
a monostable multivibrator configured to set a time duration between turning OFF the high-side switch and turning ON the low-side switch of the active clamp flyback converter based on an output of the multiplexer.

9. The circuit of claim 8, wherein sensing the reverse current sensing signal comprises sensing the reverse current flowing at the high-side switch through a capacitive current divider formed by a sense resistor and a sense capacitor coupled to the high-side switch.

10. The circuit of claim 8, wherein the first dead time duration is a function of a reverse recovery time of a body diode of the low-side switch.

11. The circuit of claim 8, wherein an input to the monostable multivibrator is a high-side control signal coupled to a control terminal of the high-side switch, the circuit further comprising:
an inverter configured to generate an inverted signal of the high-side control signal; and
an AND gate having a first input coupled to an output of the inverter, a second input of the AND gate coupled to an output of the monostable multivibrator, and an output of the AND gate coupled to a control terminal of the low-side switch.

12. The circuit of claim 8, wherein a trigger signal for the monostable multivibrator is a high-side control signal to control an operation of the high-side switch.

13. The circuit of claim 12, wherein the monostable multivibrator is configured to be triggered at a negative edge of the high-side control signal.

14. The circuit of claim 13, wherein the monostable multivibrator is configured to generate a negative pulse with a duration corresponding to the first dead time duration or the second dead time duration based on the output of the multiplexer.

15. A system, comprising:
an active clamp flyback converter comprising a high-side switch and a low-side switch; and
a circuit configured for overcurrent protection of the active clamp flyback converter, the circuit comprising:
a comparator configured to:
receive, at a first input terminal of the comparator, a reverse current sensing signal during a conduction phase of the high-side switch, the reverse current sensing signal corresponding to a reverse current flowing at the high-side switch during the conduction phase;
receive, at a second input terminal of the comparator, a threshold;
generating an output signal based on a comparison between the reverse current sensing signal and the threshold;
a multiplexer configured to select between a first input signal and a second input signal based on the output signal of the comparator, the first input signal corresponding to a first dead time duration between turning OFF the high-side switch and turning ON the low-side switch, the second input signal corresponding to a second dead time duration between turning OFF the high-side switch and turning ON the low-side switch of the active clamp flyback converter, the first dead time duration being a function of a reverse recovery time of a body diode of the low-side switch; and
a monostable multivibrator configured to set a time duration between turning OFF the high-side switch and turning ON the low-side switch of the active clamp flyback converter based on an output of the multiplexer.

16. The system of claim 15, wherein the active clamp flyback converter further comprises a sense resistor and a sense capacitor coupled to the high-side switch, wherein sensing the reverse current sensing signal comprises sensing the reverse current flowing at the high-side switch through a capacitive current divider formed by the sense resistor and the sense capacitor.

17. The system of claim 15, wherein an input to the monostable multivibrator is a high-side control signal coupled to a control terminal of the high-side switch, the circuit further comprising:
an inverter configured to generate an inverted signal of the high-side control signal; and
an AND gate having a first input coupled to an output of the inverter, a second input of the AND gate coupled to an output of the monostable multivibrator, and an output of the AND gate coupled to a control terminal of the low-side switch.

18. The system of claim 15, wherein a trigger signal for the monostable multivibrator is a high-side control signal to control an operation of the high-side switch.

19. The system of claim 18, wherein the monostable multivibrator is configured to be triggered at a negative edge of the high-side control signal.

20. The system of claim 19, wherein the monostable multivibrator is configured to generate a negative pulse with a duration corresponding to the first dead time duration or the second dead time duration based on the output of the multiplexer.
